(19) United States
(12) Patent Application Publication
(10) Pub. No.: US 2011/0002676 A1
(43) Pub. Date: Jan. 6, 2011

(54) HEATER BLOCK OF RAPID THERMAL PROCESS APPARATUS

(75) Inventors: Jang Woo Shim, Gyeonggi-do (KR); Seung Yong Kim, Gyeonggi-do (KR); Jun Her, Gyeonggi-do (KR); Dae-Cheon Hwang, Jeollabuk-do (KR)

Correspondence Address: OCCHIUTI ROHLICEK & TSAO, LLP, 10 FAWCETT STREET, CAMBRIDGE, MA, 02138, US

(73) Assignee: Asia Pacific Systems Inc., Gyeonggi-do (KR)

(21) Appl. No.: 12/745,707

(22) PCT Filed: Dec. 1, 2008
(86) PCT No.: PCT/KR08/07080

§ 371 Date: Sep. 7, 2010

(30) Foreign Application Priority Data
Dec. 3, 2007 (KR) 10-2007-0124435

(51) Int. Cl. F27D 11/12

(52) U.S. Cl. 392/411

(57) ABSTRACT

Disclosed is a separation type heater block of a rapid thermal processing apparatus, including a lamp housing formed in a plate shape, and provided with a plurality of lamp insertion holes, into which heating lamps are respectively inserted; a socket housing, into which sockets of the heating lamps are inserted, separably covered on the lamp housing; and a reflector housing provided with light emission holes at positions corresponding to the lamp insertion holes, separably installed under the lamp housing such that lower ends of the heating lamps are respectively inserted into the light emission holes, side walls of the light emission holes serving as barriers, wherein a cooling water channel, through which cooling water flows, is formed through the side walls of the light emission holes of the reflector housing.

### TECHNICAL FIELD

The present invention relates to a heater block of a rapid thermal processing apparatus, and more particularly to a separation type heater block.

### BACKGROUND ART

The key point of a rapid thermal processing (RTP) apparatus is to rapidly heat a substrate to a desired temperature within a short period of time. The rapid heating is carried out on condition that the substrate is uniformly heated. Various arrangements of heating lamps to uniformly heat the substrate have been proposed. However, since the heater block is integrally formed, the re-arrangement of the heating lamps according to a variation in a process is impossible, in actual fact.

Further, the heater block consumes the largest amount of power, and thus is the essential part of the rapid thermal processing apparatus. However, since the heater block is formed integrally, in case that a part of the heater block is damaged by heat or malfunctions due to other reasons, the part cannot be simply replaced with a new one and thus causes many problems in maintenance and repair.

Barriers, which turn light emitted from the heating lamps to the substrate to increase a rapid heating efficiency, are installed between the heating lamps. These barriers serve as a secondary indirect heat source, and thus cause non-uniformly heating of the substrate.

The conventional rapid thermal processing apparatus causes problems, such as a difficulty in maintaining and repairing the heater block due to the integral formation of the heater block, a difficulty in re-arranging the heating lamps, and non-uniform heating of the substrate due to a difficulty in cooling.

### DISCLOSURE OF INVENTION

### Technical Problem

Therefore, the present invention has been made in view of the above problems, and it is an object of the present invention to provide a separation type heater block of a rapid thermal processing apparatus, which is easily maintained and repaired, facilitates the re-arrangement of heating lamps, and is partially cooled to prevent the non-uniform heating of a substrate.

### Technical Solution

In accordance with an aspect of the present invention, the above and other objects can be accomplished by the provision of a heater block of a rapid thermal processing apparatus, including a lamp housing formed in a plate shape, and provided with a plurality of lamp insertion holes, into which heating lamps are respectively inserted; a socket housing, into which sockets of the heating lamps are inserted, separably covered on the lamp housing; and a reflector housing provided with light emission holes at positions corresponding to the lamp insertion holes, separably installed under the lamp housing such that lower ends of the heating lamps are respectively inserted into the light emission holes, side walls of the light emission holes serving as barriers, wherein a cooling water channel, through which cooling water flows, is formed through the side walls of the light emission holes of the reflector housing.

A cooling water channel, through which the cooling water flows, may be formed through side walls of the lamp insertion holes of the lamp housing.

A cooling water inlet and a cooling water outlet may be formed through the socket housing such that the cooling water flows in the socket housing.

The socket housing and the lamp housing, and the lamp housing and the socket housing may be fixed to each other by clamps under the condition that O-rings are interposed between the socket housing and the lamp housing and between the lamp housing and the socket housing.

### Advantageous Effects

The heater block of the present invention is separated and thus is easily maintained and repaired, and the lamp housing and the reflector housing are filled with cooling water just as an ink cartridge and thus it is possible to prevent the parts of the heater block from being damaged by heat and a substrate from being non-uniformly heated due to the generation of a secondary heat source.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a view illustrating a heater block of a rapid thermal processing apparatus in accordance with the present invention.

### BEST MODE FOR CARRYING OUT THE INVENTION

Now, a preferred embodiment of the present invention will be described in detail with reference to the annexed drawing. The following embodiment has been described only for a better understanding of the present invention, and those skilled in the art will appreciated that various modifications to the embodiment are possible, without departing from the scope and spirit of the invention as disclosed in the accompanying claims.

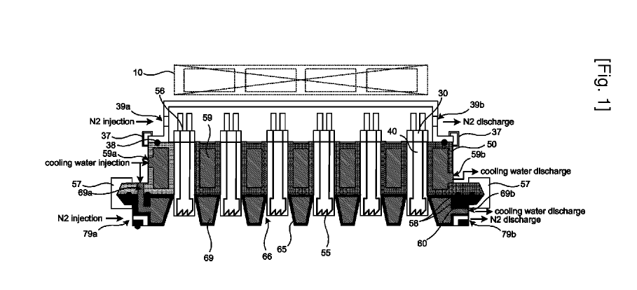

FIG. 1 is a view illustrating a heater block of a rapid thermal processing apparatus in accordance with the present invention. With reference to FIG. 1, the heater block of the present invention includes a lamp housing 50, a socket housing 30, and a reflector housing 60, which are separably connected.

The lamp housing 50 is formed in a plate shape, and a plurality of lamp insertion holes is vertically formed through the lamp housing 50. The socket housing 30 is covered on the upper surface of the lamp housing 50.

The lamp housing 50 and the socket housing 30 are fixed to each other by clamps 37 under the condition that an O-ring 38 is interposed between the lamp housing 50 and the socket housing 30. Heating lamps 40, to which power is applied through a power source 10, are inserted into the lamp housing 50 such that lamp sockets 56 of the heating lamps 40 are inserted into the socket housing 30 and lower ends 55 of the heating lamps 40 look downward.

The reflector housing 60 is formed in a plate shape, and light emission holes 66 are formed through the reflector housing 60 at positions corresponding to the lamp insertion holes and the lower ends 55 of the heating lamps 40 are inserted into the light emission holes 66. The reflector housing 60 and the lamp housing 50 are fixed to each other by clamps 57, and O-rings 58 are interposed between the reflector housing 60 and the lamp housing 50.

The light emission holes 66 are formed in a reverse conical shape, and the side walls of the light emission holes 66 serve as barriers 65. In order to serve as the barriers 65, the side walls of the light emission holes 66 are made of a material, which can reflect light, or are coated with this material.

A cooling water inlet 69a and a cooling water outlet 69b are formed through the reflector housing 60, and a cooling water channel, through which cooling water flows, is formed in the reflector housing 60. Further, a cooling water inlet 59a and a cooling water outlet 59b are formed through the lamp housing 50, and a cooling water channel, through which cooling water flows, is formed in side walls of the lamp insertion holes of the lamp housing 50. Here, reference numerals 59 and 69 respectively represent cooling water filling the lamp housing 50 and the barriers 65.

A cooling gas inlet 39a and a cooling gas outlet 39b to allow cooling gas, such as N₂, to flow into a space between the lamp housing 50 and the socket housing 30 are formed through the socket housing 30. Thus, the lamp sockets 56 are cooled by the cooling gas, such as N₂.

An atmosphere gas inlet 79a and an atmosphere gas outlet 79b to allow atmosphere gas, such as N₂, to flow into a thermal processing space located under the heater block are formed through the reflector housing 60.

### INDUSTRIAL APPLICABILITY

As apparent from the above description, the heater block in accordance with the present invention is separated into three parts, i.e., the socket housing 30, the lamp housing 50, and the reflector housing 60. Thus, although a specific part of the heater block is damaged by heat or other reasons, the respective parts of the heater block are disassembled and then the damaged part is easily repaired. Further, the barriers 65 are cooled, and thus it is possible to prevent the barriers 65 from undesirably serving as a secondary heat source.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A heater block of a rapid thermal processing apparatus, comprising:
a lamp housing formed in a plate shape, and provided with a plurality of lamp insertion holes, into which heating lamps are respectively inserted;
a socket housing, into which sockets of the heating lamps are inserted, separably covered on the lamp housing; and
a reflector housing provided with light emission holes at positions corresponding to the lamp insertion holes, separably installed under the lamp housing such that lower ends of the heating lamps are respectively inserted into the light emission holes, side walls of the light emission holes serving as barriers,
wherein a cooling water channel, through which cooling water flows, is formed through the side walls of the light emission holes of the reflector housing.

2. The heater block according to claim 1, wherein a cooling water channel, through which the cooling water flows, is formed through side walls of the lamp insertion holes of the lamp housing.

3. The heater block according to claim 1, wherein a cooling water inlet and a cooling water outlet are formed through the socket housing such that the cooling water flows in the socket housing.

4. The heater block according to claim 1, wherein the socket housing and the lamp housing, and the lamp housing and the socket housing are fixed to each other by clamps under the condition that O-rings are interposed between the socket housing and the lamp housing and between the lamp housing and the socket housing.
